(19) United States
(12) Patent Application Publication
(10) Pub. No.: US 2024/0023617 A1
(43) Pub. Date: Jan. 25, 2024

(54) VAPORIZER AND ELECTRONIC VAPORIZATION DEVICE WITH THE VAPORIZER

(71) Applicant: SHENZHEN FIRST UNION TECHNOLOGY CO., LTD., Shenzhen City, Guangdong Province (CN)

(72) Inventors: WEIFENG GONG, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/266,262

(22) PCT Filed: Dec. 8, 2021
(86) PCT No.: PCT/CN2021/136487

§ 371 Date: Jun. 8, 2023

(30) Foreign Application Priority Data
Dec. 9, 2020 (CN) 202022959371.6

(51) Int. Cl. A24F 40/46; A24F 40/10; A24F 40/44; A24F 40/48; A24F 40/42; A24F 40/30; H05B 3/22

(52) U.S. Cl. CPC A24F 40/46; A24F 40/10; A24F 40/44; A24F 40/48; A24F 40/42; A24F 40/30; H05B 3/22

(57) ABSTRACT

A vaporizer includes an air inlet, an air outlet, and an airflow channel from the air inlet to the air outlet a liquid storage cavity storing a liquid aerosol-forming substrate; a first porous substrate, including a first liquid absorbing surface and a first vaporization surface, where the first liquid absorbing surface is in fluid communication with the liquid storage cavity, and a first heating element to heat the liquid aerosol-forming substrate is formed on the first vaporization surface; and a second porous substrate, including a second liquid absorbing surface and a second vaporization surface, where the second liquid absorbing surface is in fluid communication with the liquid storage cavity, and a second heating element configured to heat the liquid aerosol-forming substrate is formed on the second vaporization surface; and both the first vaporization surface and the second vaporization surface are in a flat shape and exposed to the airflow channel.

### CROSS-REFERENCE TO RELATED APPLICATIONS

This application claims priority to Chinese Patent Application No. 202022959371.6, entitled “VAPORIZER AND ELECTRONIC VAPORIZATION DEVICE WITH THE VAPORIZER” and filed with the China National Intellectual Property Administration on Dec. 9, 2020, which is incorporated herein by reference in its entirety.

### TECHNICAL FIELD

This application relates to the technical field of cigarette devices, and in particular, to a vaporizer and an electronic vaporization device with the vaporizer.

### BACKGROUND

An electronic vaporization device is an electronic product that generates vapor for a user to inhale by heating e-liquid. The electronic vaporization device generally includes two parts: a vaporizer and a power supply component. E-liquid is stored in the vaporizer and a vaporization core configured to heat the e-liquid is arranged in the vaporizer, and the power supply component includes a battery and a circuit board. The power supply component can supply power to the vaporization core, so that the vaporization core generates a high temperature to heat the e-liquid.

The existing electronic vaporization device has the following problem: a vaporization area is small, resulting in low total particulate matter (TPM) in vapor and poor inhaling experience of a user.

### SUMMARY

This application provides a vaporizer and an electronic vaporization device with the vaporizer, to resolve problems of a small vaporization area and low total particulate matter in vapor existing in the existing electronic vaporization device.

This application provides a vaporizer, including:
an air inlet, an air outlet, and an airflow channel from the air inlet to the air outlet;
a liquid storage cavity, for storing a liquid aerosol-forming substrate;
a first porous substrate, including a first liquid absorbing surface and a first vaporization surface relative to the first liquid absorbing surface, where the first liquid absorbing surface is in fluid communication with the liquid storage cavity, and a first heating element configured to heat the liquid aerosol-forming substrate is formed on the first vaporization surface; and
a second porous substrate, including a second liquid absorbing surface and a second vaporization surface relative to the second liquid absorbing surface, where the second liquid absorbing surface is in fluid communication with the liquid storage cavity, and a second heating element configured to heat the liquid aerosol-forming substrate is formed on the second vaporization surface; and
both the first vaporization surface and the second vaporization surface are in a flat shape and exposed to the airflow channel.

This application further provides an electronic vaporization device, including the vaporizer and a power supply device configured to supply power to the vaporizer.

The vaporizer and the electronic vaporization device with the vaporizer provided in this application can increase a vaporization area through the first porous substrate and the second porous substrate, thereby increasing total particulate matter in vapor and improving inhaling experience of a user.

### BRIEF DESCRIPTION OF THE DRAWINGS

The objective implementation, functional features, and advantages of this application are further illustrated with reference to the embodiments and the accompanying drawings. One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an electronic vaporization device according to an embodiment of this application;

FIG. 2 is a schematic diagram of a vaporizer in an electronic vaporization device according to an embodiment of this application;

FIG. 3 is a schematic exploded view of a vaporizer according to an embodiment of this application;

FIG. 4 is a schematic cross-sectional view of a vaporizer according to an embodiment of this application;

FIG. 5 is a schematic diagram of a narrow channel and a wider channel in a vaporizer according to an embodiment of this application;

FIG. 6 is a schematic diagram of a porous substrate in a vaporizer according to an embodiment of this application;

FIG. 7 is a schematic diagram of a porous substrate in a vaporizer from another perspective according to an embodiment of this application;

FIG. 8 is a schematic diagram of a holder in a vaporizer according to an embodiment of this application;

FIG. 9 is a schematic diagram of a holder in a vaporizer from another perspective according to an embodiment of this application;

FIG. 10 is a schematic top view of a holder in a vaporizer according to an embodiment of this application;

FIG. 11 is a schematic diagram of a seal member in a vaporizer according to an embodiment of this application;

FIG. 12 is a schematic diagram of a seal member in a vaporizer from another perspective according to an embodiment of this application; and

FIG. 13 is a schematic diagram of a base in a vaporizer according to an embodiment of this application.

### DETAILED DESCRIPTION

It should be understood that the specific embodiments described herein are merely used for explaining this application but are not intended to limit this application. For ease of understanding of this application, this application is described below in more detail with reference to the accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. The term “and/or” used in this specification includes any or all combinations of one or more associated related listed items.

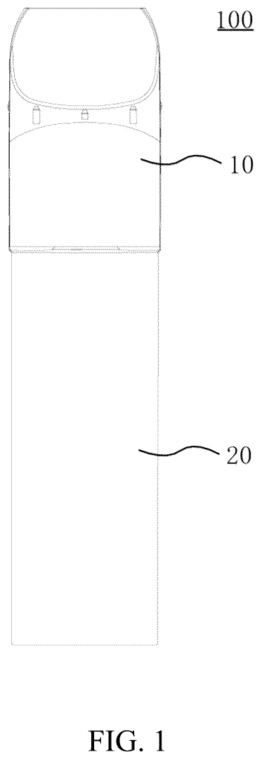

As shown in FIG. 1, an electronic vaporization device 100 includes a vaporizer 10 and a main body 20.

The vaporizer 10 is detachably connected to the main body 20, including but not limited to a buckle connection, a magnetic connection, and a screw connection. In another example, that the vaporizer 10 and the main body 20 are designed as a whole is also feasible.

The main body 20 includes a power supply device (not shown) for supplying power to the vaporizer 10, and the power supply device may be a rechargeable battery or a disposable battery.

The main body 20 further includes a circuit (not shown) that controls an overall operation of the electronic vaporization device 100. The circuit includes at least one processor. The processor may include a logic gate array or may include a combination of a general purpose microprocessor and a memory storing programs executable in the microprocessor. In addition, it should be understood by a person skilled in the art that the circuit may include another type of hardware.

It should be noted that, the electronic vaporization device 100 may further include other general purpose components except the foregoing components.

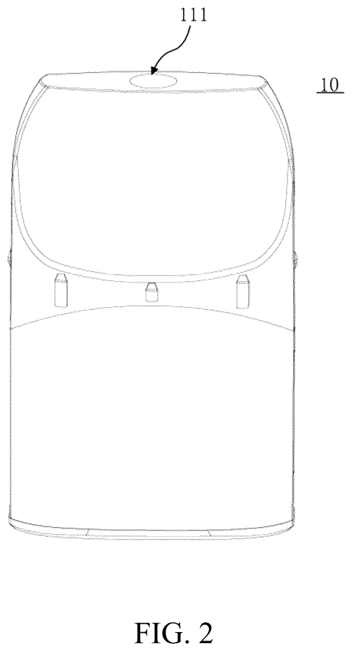

As shown in FIG. 2 to FIG. 4, the vaporizer 10 includes a housing 11, a seal member 12, a conductive connecting piece 13, a holder 14, a porous substrate 15, a porous substrate 16, a conductive connecting piece 17, a conductive connecting piece 18, a seal member 19, a base 20, a connector 21, and a connector 22.

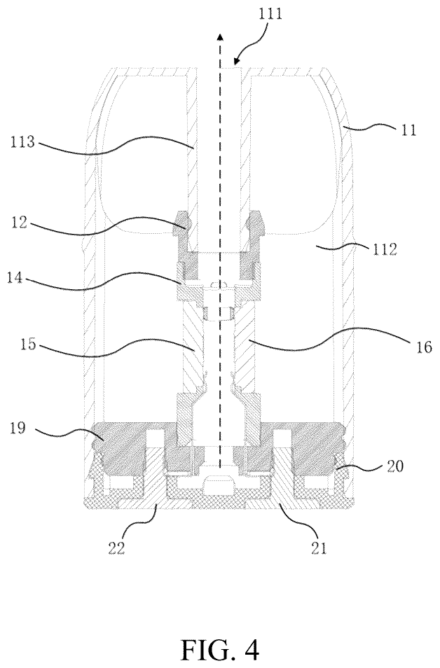

The housing 11 includes a suction nozzle end and an open end. The suction nozzle end includes an air outlet 111, and an aerosol after heating and vaporization can be inhaled by a user through the air outlet 111. The base 20 is arranged on the open end and is at least partially accommodated in the housing 11. The base 20 and the housing 11 are in a buckle connection, but a connection manner is not limited to this. A liquid storage cavity 112 is formed between the base 20 and an inner wall of the housing 11, and the liquid storage cavity 112 is for storing a liquid aerosol-forming substrate that can generate an aerosol. The housing 11 further includes an integrally formed air guide tube 113, an inner surface of the air guide tube 113 defines a part of an airflow channel (shown by a dashed arrow in FIG. 4), one end of the air guide tube 113 is in communication with the air outlet 111, and the other end is connected to the holder 14. Further, to prevent the liquid aerosol-forming substrate from flowing into the airflow channel from a gap between the air guide tube 113 and the holder 14, a seal member 12 may be arranged between the air guide tube 113 and the holder 14. It should be noted that, in another example, that the air guide tube 113 may be formed from a separate hollow tube is also feasible.

The holder 14 is configured to hold the porous substrate 15, the porous substrate 16, and the conductive connecting piece 13. The holder 14 is arranged in the housing 11 and is located between the base 20 and the air outlet 111. One end of the holder 14 is connected to the air guide tube 113, and the other end is connected to the base 20. Further, to prevent the liquid aerosol-forming substrate from flowing out of a gap between the holder 14 and the base 20, a seal member 19 may be arranged between the holder 14 and the base 20.

In this example, to facilitate manufacturing, both the porous substrate 15 and the porous substrate 16 are configured in a plate shape or a sheet shape, and a shape of the porous substrate 15 and a shape of the porous substrate 16 are maintained to be consistent.

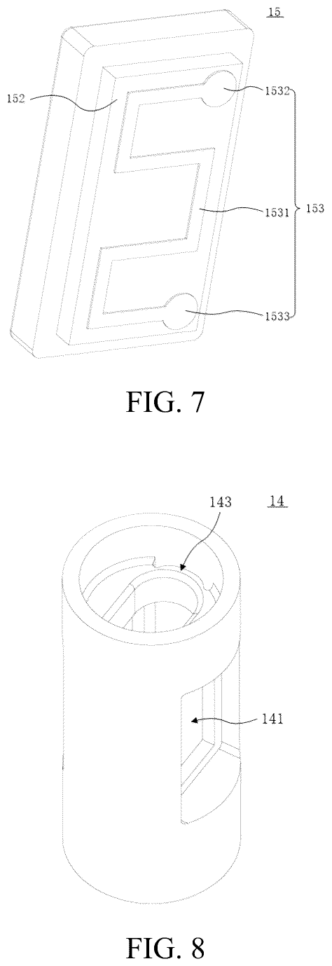

Referring to FIG. 6 and FIG. 7, the porous substrate 15 includes a liquid absorbing surface 151 and a vaporization surface 152 relative to the liquid absorbing surface 151. The liquid absorbing surface 151 is in fluid communication with the liquid storage cavity 112, and a heating element 153 configured to heat the liquid aerosol-forming substrate is formed on the vaporization surface 152. In this example, the heating element 153 includes a conductive track 1531, a contact point 1532, and a contact point 1533. The heating element 153 may be formed on the vaporization surface 152 through silk screen printing, and a material of the heating element 153 includes, but is not limited to, nickel, chromium, nickel-chromium alloy, or stainless steel. The porous substrate 15 is made of a porous material such as porous ceramics, porous glass ceramics, porous glass, or the like.

The holder 14 is in a hollow shape, and an inner surface of the holder 14, the vaporization surface 152 of the porous substrate 15, and a vaporization surface of the porous substrate 16 jointly define a part of the airflow channel, and both the vaporization surface 152 of the porous substrate 15 and the vaporization surface of the porous substrate 16 are in a flat shape. The conductive connecting piece 13 is configured to connect the heating element 153 on the porous substrate 15 and a heating element on the porous substrate 16 in series.

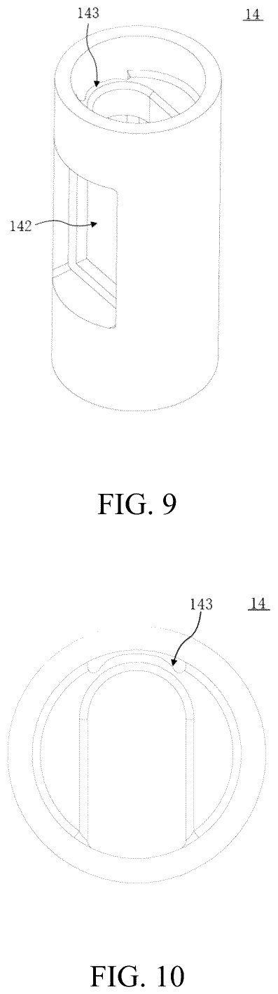

Referring to FIG. 8 to FIG. 10, the holder 14 is in a shape of a hollow tube, and a circumferential surface of the hollow tube is provided with a through hole 141 and a through hole 142 that are recessed in a radial direction. A size of the through hole 141 is consistent with a size of the porous substrate 15 and may be slightly smaller than that of the porous substrate so that the porous substrate 15 is held on the through hole 141. During mounting, the vaporization surface 152 faces the airflow channel and the liquid absorbing surface 151 is placed facing away from the airflow channel, that is, after mounting, the vaporization surface 152 is exposed to the airflow channel. The through hole 142 and the porous substrate 16 are similar to this. A via hole 143 is further provided in the hollow tube. After the conductive connecting piece 13 is respectively connected to the contact point 1532 of the heating element 153 on the porous substrate 15 and a contact point of the heating element on the porous substrate 16, a part of the conductive connecting piece 13 may extend from the via hole 143 for coupling with an external power source, thereby connecting the heating element 153 on the porous substrate 15 and the heating element on the porous substrate 16 in series.

Preferably, through the arrangement of the through hole 141 and the through hole 142, after the porous substrate 15 and the porous substrate 16 are respectively mounted on the through hole 141 and the through hole 142, the vaporization surface 152 of the porous substrate and the vaporization surface of the porous substrate 16 are arranged at intervals in a circumferential direction around a part of the airflow channel and are both arranged in parallel with an extending direction of the airflow channel. The vaporization surface 152 of the porous substrate 15 and the vaporization surface of the porous substrate 16 are also arranged in parallel and are arranged in a face-to-face manner. In this way, a vaporization area can be increased, thereby improving total particulate matter in vapor.

It should be noted that, since both the porous substrate 15 and the porous substrate 16 are configured in a plate shape or a sheet shape, and the vaporization surface 152 of the porous substrate 15 and the vaporization surface of the porous substrate 16 are both in a flat shape, it can be easily imagined that the arrangement of the porous substrate 15 and the porous substrate 16, or the arrangement of the vaporization surface 152 of the porous substrate 15 and the vaporization surface of the porous substrate 16 is not limited to the situation shown in the accompanying drawings. For example: the porous substrate 15 and the porous substrate 16 may be arranged up and down, a part of the vaporization surface 152 of the porous substrate 15 and a part of the vaporization surface of the porous substrate 16 may be arranged at intervals in the circumferential direction around a part of the airflow channel.

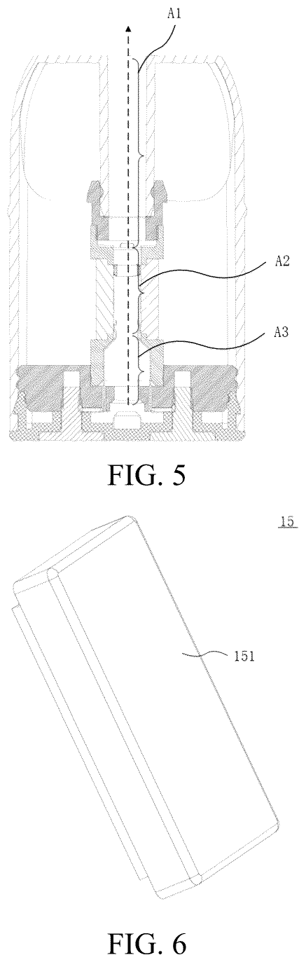

Referring to FIG. 5, the airflow channel (shown by a dashed arrow in FIG. 5) generally includes a wider channel A1, a narrow channel A2, and a wider channel A3 in the extending direction of the airflow channel. The narrow channel A2 is defined by the vaporization surface 152 of the porous substrate 15, the vaporization surface of the porous substrate 16, and the inner surface of the holder 14. The narrow channel A2 is sufficiently narrow, so that a sufficiently large negative pressure is generated on the vaporization surface 152 of the porous substrate 15 and the vaporization surface of the porous substrate 16 due to a Venturi effect during operation of the electronic vaporization device by a user, thereby allowing the liquid aerosol-forming substrate to flow smoothly from the liquid storage cavity 112 to the vaporization surface of the porous substrate through the liquid absorbing surface of the porous substrate. Generally, a distance between the vaporization surface 152 of the porous substrate 15 and the vaporization surface of the porous substrate 16 is between 0.5 mm and 1.5 mm.

The wider channel A1 is defined by the air guide tube 113, the wider channel A3 is defined by a part of the holder 14 and the seal member 19, and widths of both the wider channel A1 and the wider channel A3 are greater than a width of the narrow channel A2, namely, the distance between the vaporization surface 152 of the porous substrate 15 and the vaporization surface of the porous substrate 16. From the wider channel A3 to the narrow channel A2, as the width decreases, pressure increases, so that a sufficiently large negative pressure is generated on the vaporization surface 152 of the porous substrate 15 and the vaporization surface of the porous substrate 16. From the narrow channel A2 to the wider channel A1, as the width increases, pressure decreases.

Preferably, the holder 14, the conductive connecting piece 13, the porous substrate 15, and the porous substrate 16 may be integrally formed. For example: a moldable material is molded around a side surface of the porous substrate 15 and a side surface the porous substrate 16. An integrally formed structure has a good seal effect, and the liquid aerosol-forming substrate does not flow into the airflow channel from a gap between the porous substrate 15 (or the porous substrate 16) and the holder 14. It is readily imagined that the holder 14, the conductive connecting piece 13, the porous base 15, and the porous base 16 may not be integrally formed, and that a seal member is arranged between the porous substrate 15 (or the porous substrate 16) and the holder 14 is also feasible.

It should be noted that, the arrangement of the through hole 141 and the through hole 142 is not limited to the foregoing case, as long as a projection of the vaporization surface 152 of the porous substrate 15 on the airflow channel and a projection of the vaporization surface of the porous substrate 16 on the airflow channel can be at least partially overlapped.

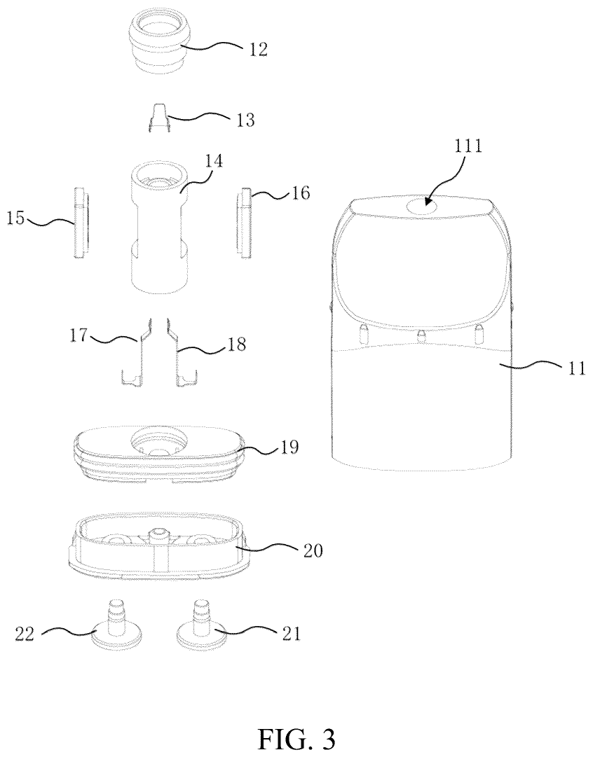

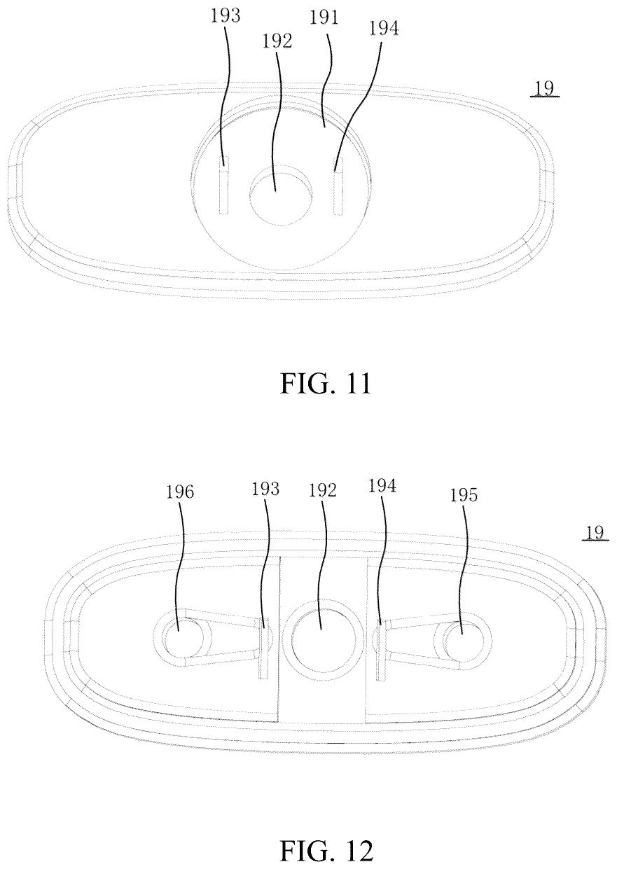

Referring to FIG. 3 and FIG. 4, and FIG. 11 and FIG. 12, the seal member 19 includes an accommodating cavity 191, an airflow through hole 192, a via hole 193, a via hole 194, an accommodating cavity 195, and an accommodating cavity 196.

The accommodating cavity 191 is for accommodating a part of the holder 14 to hold an end portion of the holder 14 and an inner surface of the airflow through hole 192 to define a part of the airflow channel. After one end of the conductive connecting piece 17 is connected to the contact point 1533 of the heating element 153 on the porous substrate 15, a part of the conductive connecting piece 17 is accommodated in the accommodating cavity 196 through the via hole 193. The connector 22 is also accommodated in the accommodating cavity 196 after passing through the base 20, thereby maintaining contact with a part of the conductive connecting piece 17 to form an electrical connection. After one end of the conductive connecting piece 18 is connected to the contact point of the heating element on the porous substrate 16, a part of the conductive connecting piece 18 is accommodated in the accommodating cavity 195 through the via hole 194. The connector 21 is also accommodated in the accommodating cavity 195 after passing through the base 20, thereby maintaining contact with a part of the conductive connecting piece 18 to form an electrical connection. The accommodating cavity 195 and the accommodating cavity 196 are respectively recessed and formed in a direction of the airflow channel, and the accommodating cavity 191 is recessed and formed in a direction opposite to the airflow channel, and recessed lengths thereof are less than a length of the seal member 19 in the direction of the airflow channel.

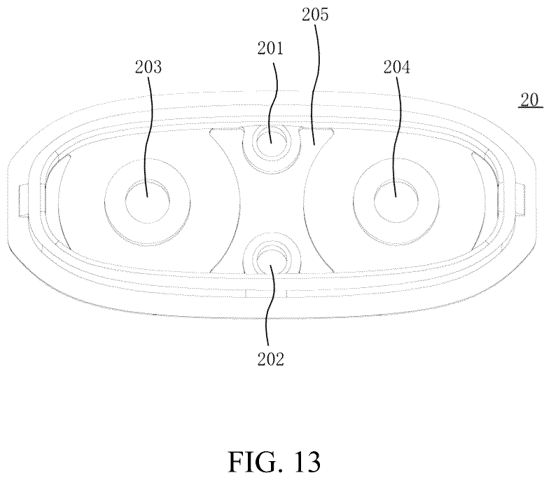

Referring to FIG. 3 and FIG. 4, and FIG. 13, the base 20 includes an air inlet 201, an air inlet 202, a via hole 203, a via hole 204, and a collection cavity 205.

Both the air inlet 201 and the air inlet 202 are staggered from the airflow through hole 192 of the seal member 19 in a thickness direction of the vaporizer 10 to prevent condensate from flowing out of the air inlet 201 and the air inlet 202. The collection cavity 205 is for collecting the condensate, and the collection cavity 205 is recessed and formed in the direction opposite to the airflow channel. The connector 22 is accommodated in the accommodating cavity 196 after passing through the via hole 203, and the connector 21 is accommodated in the accommodating cavity 195 after passing through the via hole 204.

In another example, the liquid storage cavity 112 includes a first liquid storage cavity and a second liquid storage cavity.

The first liquid storage cavity is for storing a first liquid aerosol-forming substrate. The liquid absorbing surface 151 of the porous substrate 15 is in fluid communication with the first liquid storage cavity, and the heating element 153 on the porous substrate 15 is configured to heat the first liquid aerosol-forming substrate.

The second liquid storage cavity is for storing a second liquid aerosol-forming substrate. A liquid absorbing surface of the porous substrate 16 is in fluid communication with the second liquid storage cavity and the heating element on the porous substrate 16 is configured to heat the second liquid aerosol-forming substrate.

In this example, the first liquid storage cavity and the second liquid storage cavity may be separated from each other without fluid communication or may be separated from each other with fluid communication. Compositions of the first liquid aerosol-forming substrate and compositions of the second liquid aerosol-forming substrate may be the same or different. Preferably, the first liquid storage cavity and the second liquid storage cavity may be separated from each other without fluid communication, and compositions of the first liquid aerosol-forming substrate and compositions of the second liquid aerosol-forming substrate are different.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or variations according to the above descriptions, and such improvements and variations shall all fall within the protection scope of the appended claims of this application.

1: A vaporizer, comprising:
an air inlet, an air outlet, and an airflow channel from the air inlet to the air outlet;
a liquid storage cavity, for storing a liquid aerosol-forming substrate;
a first porous substrate, comprising a first liquid absorbing surface and a first vaporization surface relative to the first liquid absorbing surface, wherein the first liquid absorbing surface is in fluid communication with the liquid storage cavity, and a first heating element configured to heat the liquid aerosol-forming substrate is formed on the first vaporization surface; and
a second porous substrate, comprising a second liquid absorbing surface and a second vaporization surface relative to the second liquid absorbing surface, wherein the second liquid absorbing surface is in fluid communication with the liquid storage cavity, and a second heating element configured to heat the liquid aerosol-forming substrate is formed on the second vaporization surface; and
both the first vaporization surface and the second vaporization surface are in a flat shape and exposed to the airflow channel.

2: The vaporizer according to claim 1, wherein the first vaporization surface and the second vaporization surface are arranged at intervals in a circumferential direction around a part of the airflow channel.

3: The vaporizer according to claim 2, wherein the first vaporization surface and the second vaporization surface are arranged in parallel with an extending direction of the airflow channel.

4: The vaporizer according to claim 3, wherein the first vaporization surface and the second vaporization surface are arranged in a face-to-face manner.

5: The vaporizer according to claim 1, wherein the airflow channel comprises a narrow channel and at least one wider channel in an extending direction of the airflow channel; and the first vaporization surface and the second vaporization surface define a part of the narrow channel.

6: The vaporizer according to claim 5, wherein a distance between the first vaporization surface and the second vaporization surface is between 0.5 mm and 1.5 mm.

7: The vaporizer according to claim 1, wherein both the first porous substrate and the second porous substrate are configured in a plate shape or a sheet shape.

8: The vaporizer according to claim 1, wherein the vaporizer further comprises a holder, configured to hold the first porous substrate and the second porous substrate.

9: The vaporizer according to claim 8, wherein the holder is in a hollow shape, and an inner surface of the holder, the first vaporization surface, and the second vaporization surface jointly define a part of the airflow channel.

10: The vaporizer according to claim 8, wherein the vaporizer further comprises a conductive connecting piece held on the holder, and the conductive connecting piece is configured to connect the first heating element and the second heating element in series.

11: The vaporizer according to claim 8, wherein the holder, the first porous substrate, and the second porous substrate are integrally formed.

12: The vaporizer according to claim 8, wherein the vaporizer further comprises a housing and a base;
the housing comprises a suction nozzle end and an open end, and the base is arranged on the open end;
the air outlet is provided on the suction nozzle end, and the air inlet is provided on the base; and
the holder, the first porous substrate, and the second porous substrate are arranged in the housing and are located between the base and the air outlet.

13: The vaporizer according to claim 12, wherein the vaporizer further comprises an air guide tube, the air guide tube is in communication with the air outlet, and an inner surface of the air guide tube defines a part of the airflow channel; and
one end of the holder is connected to the air guide tube, and the other end is connected to the base.

14: The vaporizer according to claim 1, wherein the liquid storage cavity comprises a first liquid storage cavity and a second liquid storage cavity;
the first liquid storage cavity is for storing a first liquid aerosol-forming substrate, the first liquid absorbing surface is in fluid communication with the first liquid storage cavity, and the first heating element is configured to heat the first liquid aerosol-forming substrate; and
the second liquid storage cavity is for storing a second liquid aerosol-forming substrate, the second liquid absorbing surface is in fluid communication with the second liquid storage cavity, and the second heating element is configured to heat the second liquid aerosol-forming substrate.

15: An electronic vaporization device, comprising the vaporizer according to claim 1, and a power supply device configured to supply power to the vaporizer.
